(19) United States
(12) Patent Application Publication
(10) Pub. No.: US 2026/0212400 A1
(43) Pub. Date: Jul. 23, 2026

(54) Multi-Party Semi-Supervised Learning Method for Recommending Potential Users of Financial Products

(71) Applicant: Chongqing University of Posts and Telecommunications, Chongqing (CN)

(72) Inventors: Feng Chen, Chongqing (CN); Ying Qian, Chongqing (CN); Xin Liu, Chongqing (CN); Qingjie Wei, Chongqing (CN)

(21) Appl. No.: 19/141,326

(22) PCT Filed: May 6, 2024
(86) PCT No.: PCT/CN2024/091099

§ 371 Date: Jun. 20, 2025

(30) Foreign Application Priority Data
May 8, 2023 (CN) CN202310508313.7

(51) Int. Cl. G06Q 30/0601; G06N 3/0895; G06N 3/098; G06Q 40/06

(52) U.S. Cl. CPC G06Q 30/0631; G06N 3/0895; G06N 3/098; G06Q 40/0631

(57) ABSTRACT

The present invention relates to a multi-party semi-supervised learning method for recommending potential users of financial products, and falls within the field of big data recommendation. To address the challenge faced by financial product providers who possess only positive labeled data and thus cannot perform effective customer recommendation, the method conducts multiple rounds of random sampling on unlabeled data from multiple other parties while preserving data privacy and security. Through this process, multiple balanced binary classification datasets comprising both positive and pseudo-negative samples are constructed. Based on each balanced dataset, a vertical federated learning model is then trained using a base estimator. Based on the collective prediction results generated by the vertical federated learning models, reliable positive samples are identified from the unlabeled data. The overall dataset is iteratively updated to repeat the sampling, model training, and prediction processes, enabling the progressive extraction of batches of reliable positive samples. This method effectively supports batch recommendation in scenarios where the party seeking recommendation services possesses only a small number of positive samples while other parties have large volume of unlabeled data. The method significantly improves the reliability, accuracy, and scalability of financial products recommendation to potential users.

### CROSS-REFERENCES TO RELATED APPLICATIONS

This application is the US National Phase Entry of International Application Serial No. PCT/CN2024/091099 filed on May 6, 2024, which claims priority to Chinese Patent Application Serial No. CN202310508313.7 filed on May 8, 2023, which are each hereby incorporated herein by reference in its entirety.

### FIELD OF THE INVENTION

The present invention relates to the field of big data-based recommendation technologies, and more particularly to a method for recommending financial products to potential users based on joint multi-party semi-supervised learning.

### BACKGROUND OF THE INVENTION

With the continuous development of the socio-economic environment, an increasing number of financial institutions are offering a wide variety of financial products to user groups with diverse characteristics. Financial products refer to various financial services and offerings provided by banks, securities firms, insurance institutions, and housing fund organizations, including but not limited to loans, credit cards, mutual funds, stocks, and housing fund deposits. Given the diversity of user needs across different financial products, accurately and promptly recommending a newly released financial product to appropriate potential users has become a significant challenge. By leveraging machine learning and big data technologies, it is possible to analyze the characteristics of customers who have already purchased the specific financial product from a financial institution, and to identify potential users who share similar characteristics among those who have not yet made such purchases, thereby enabling accurate recommendation to the institution and satisfying both user and institutional needs. Nevertheless, in situations where a financial institution possesses only a limited amount of information on users who have purchased the product and lacks sufficient data on those who have not, it becomes necessary to supplement the data by obtaining information from other institutions or existing resources. Due to stringent data privacy and security protection requirements, data from different parties are isolated, forming so-called data silos. This isolation severely limits the ability of participants to aggregate data for building higher-performance machine learning models, thereby impeding accurate recommendation efforts.

### SUMMARY OF INVENTION

In view of the above, an objective of the present invention is to provide a method for recommending financial products to potential users based on joint multi-party semi-supervised learning.

To achieve this objective, the present invention provides the following technical solution:

A multi-party semi-supervised learning method for recommending potential users of financial products, comprising the following steps:
S1: constructing a multi-party dataset for recommending potential users to a financial product; the dataset comprising information of users who have purchased the financial product and users information from other parties; preprocessing the dataset and performing sample alignment to construct a positive sample dataset and an unlabeled sample dataset;
S2: performing random sampling with replacement on the unlabeled sample dataset to construct a negative sample dataset; constructing a training set using the negative sample dataset and the positive sample dataset; constructing a prediction set using unsampled data from the unlabeled sample dataset; constructing a vertical federated learning model based on a base estimator, training the model on the training set and performing prediction on the prediction set, and then obtaining a prediction score for each sample in the prediction set;
S3: repeating the sampling, training, and prediction processes of step S2 multiple times; calculating a probability of each sample in the unlabeled sample dataset being positive, based on a cumulative prediction score and a number of times it appeared in the prediction sets; ranking all samples in the unlabeled sample dataset in descending order according to the probability of being positive; selecting the top-ranked samples as reliable positive samples according to prior knowledge; adding the reliable positive samples to the positive sample dataset; and simultaneously removing the reliable positive samples from the unlabeled sample dataset;
S4: repeating steps S2 to S3 until a preset maximum number of iterations is reached, whereby all reliable positive samples identified from the unlabeled sample dataset are designated as potential users of the financial product, such that accurate and scalable batch recommendations can be provided to financial product providers based on the designated potential users.

Further, the multi-party dataset for recommending potential users of the financial product in step S1 comprises Party A who holds the information of users that have purchased the financial product, and further comprises Party B and Party C as additional data sources distinct from Party A. Step S1 specifically comprises the following steps:
S11: performing data preprocessing on the multi-party dataset for recommending potential users of the financial product, including processing of redundant data, handling of missing values, treatment of outliers, data normalization, and label data processing, to obtain a dataset of Party A:

$${D}_{A} = \{ ( {x}_{i}^{A} , {y}_{i}^{A} ) \} ,$$

wherein

$${x}_{i}^{A}$$

denotes a feature vector of an i-th sample from Party A, d_{A} denotes a vector dimension of

$${x}_{i}^{A} , and {y}_{i}^{A} ∈ \{ 1 \}$$

denotes a corresponding label of

$${x}_{i}^{A} ,$$

where i=1, . . . , a; a dataset of Party B:

$${D}_{B} = \{ ( {x}_{i}^{B} , {y}_{i}^{B} ) \} ,$$

wherein

$${x}_{i}^{B}$$

denotes a feature vector of the i-th sample from Party B, d_{B} denotes a vector dimension of

$${x}_{i}^{B} ,$$

and

$${y}_{i}^{B} ∈ \{ 0 \}$$

denotes a corresponding label of

$${x}_{i}^{B} ,$$

where i=1, . . . , b; a dataset of Party C:

$${D}_{C} = \{ ( {x}_{i}^{C} , {y}_{i}^{C} ) \} ,$$

wherein

$${x}_{i}^{C}$$

denotes a vector dimension of an i-th sample from Party C, d_{C} denotes a vector dimension of

$${x}_{i}^{C} , and {y}_{i}^{C} ∈ \{ 0 \}$$

denotes a corresponding label of

$${x}_{i}^{C} ,$$

S12: performing encrypted sample alignment between the dataset of Party B and the dataset of Party C based on their sample IDs; retaining the sample data resulting from the encrypted alignment between Party B and Party C, and discarding the unaligned sample data, so as to obtain n aligned samples; an aligned dataset of Party B is denoted as

$${D}_{A l i g n}^{B} = \{ ( {x}_{i}^{B} , {y}_{i}^{B} ) \} ,$$

and an aligned dataset of Party C is denoted as

$${D}_{A l i g n}^{C} = \{ ( {x}_{i}^{C} , {y}_{i}^{C} ) \} ; {y}_{i}^{B} ∈ \{ 0 \}$$

represents the corresponding label of

$${x}_{i}^{B} , and {y}_{i}^{C} ∈ \{ 0 \}$$

represents the corresponding label of

$${x}_{i}^{C} ,$$

where i=1, . . . , n.
S13: performing encrypted sample alignment between the dataset of Party A, the aligned dataset of Party B and the aligned dataset of Party C based on their sample IDs; the aligned samples from all three parties are used as positive samples to construct the positive sample dataset: P={(xpᵢ, ypᵢ)}, where

$$x {p}_{i} = ( {xp}_{i}^{A} , {xp}_{i}^{B} , {xp}_{i}^{C} ) , {xp}_{i}^{A} {xp}_{i}^{B} and {xp}_{i}^{C}$$

represent the aligned feature vectors of the i-th sample from Party A, Party B, and Party C, respectively, ypᵢ∈{1} denotes the positive sample label, and |P| is the number of positive samples, i=1, . . . , |P|; the samples not jointly aligned among the three parties are considered unlabeled samples and used to construct the unlabeled sample dataset: U={(xuᵢ, yuᵢ)}, where

$$x {u}_{i} = ( x {u}_{i}^{B} , {xu}_{i}^{C} ) , and {xu}_{i}^{B} and {xu}_{i}^{C}$$

represent the aligned feature vectors of the i-th sample from Party B and Party C, respectively, yuᵢ∈{0} denotes the unlabeled sample label, and |U| is the number of the unlabeled samples, i=1, . . . , |U|.

Further, in step S11, the processing of redundant data specifically comprises determining whether data records are duplicated by examining certain fields within each record, retaining only a single instance of each duplicated data record, and removing the remaining duplicates from the dataset, while preserving a backup of the original data to allow for retrospective and comparative analysis when needed; the handling of missing values specifically comprises calculating a missing rate for each feature in the data, treating any data record with a number of missing features exceeding half of the total feature dimension as invalid data, and removing such invalid data from the dataset; the remaining incomplete data are imputed using specific methods selected according to the data distribution; the treatment of outliers specifically comprises determining threshold values for outliers based on actual business or data conditions; performing visual data analysis to identify data points exceeding the threshold; processing the identified outliers accordingly; and rechecking the dataset post-processing to ensure that all outliers have been handled and that the fundamental statistical characteristics of the dataset remain substantially unchanged; the data normalization specifically comprises classifying existing features into continuous features and discrete features based on data types; applying min-max normalization to the continuous features, and applying one-hot encoding to the discrete features; the label data processing specifically comprises adding a label column to the dataset of Party A and assigning a label value of “1” to represent positive sample data; and respectively adding a label column to the datasets of Party B and Party C with a label value of “0” to represent unlabeled data.

Further, step S2 specifically comprises: establishing a candidate recommendation process for predicting the unlabeled samples, and iteratively executing the candidate recommendation process until M rounds are completed, wherein the m-th round of the candidate recommendation process is as follows: randomly sampling with replacement a total of | P| samples from the unlabeled sample dataset U, where |P| denotes the number of samples in the positive sample dataset P, using the |P| samples to form the negative sample dataset: N^{m}; constructing the training dataset using P and N^{m}:

$${X}_{train}^{m} ,$$

constructing the prediction dataset

$${X}_{test}^{m}$$

using the remaining unsampled samples from U; constructing the vertical federated learning model using Gradient Boosting Decision Tree (GBDT) as the base estimator and training the model on

$${X}_{train}^{m} ;$$

performing prediction on

$${X}_{test}^{m}$$

by inputting it into the trained vertical federated model, and obtaining the prediction score for each sample in

$${X}_{test}^{m} ;$$

the prediction process of the m-th round of the candidate recommendation process for the unlabeled samples specifically comprises the following steps:
S21: using bootstrap sampling to randomly sample with replacement |P| samples from the unlabeled sample dataset U to construct the m-th round negative sample dataset:

$${N}^{m} = \{ ( {xn}_{i}^{m} , {yn}_{i}^{m} ) \} ,$$

where

$$x {n}_{i}^{m} = ( x {n}_{i}^{m , B} , {xn}_{i}^{m , C} ) , x {n}_{i}^{m , B} and {xn}_{i}^{m , C}$$

represent the feature vectors of the i-th negative sample in round m from Party B and Party C respectively, and

$${yn}_{i}^{m} ∈ \{ - 1 \}$$

denotes the corresponding label, i=1, 2, . . . , 2|P|; |N^{m}| denotes the number of samples in the m-th round negative sample dataset N™; the positive sample dataset P and the negative sample dataset N^{m} are used to construct the m-th round training set:

$${X}_{train}^{m} = \{ ( {xtr}_{i}^{m} , {ytr}_{i}^{m} ) \} ,$$

where

$$x t {r}_{i}^{m} = ( x t {r}_{i}^{m , B} , xt {r}_{i}^{m , C} ) ; x t {r}_{i}^{m , B} and {xtr}_{i}^{m , C}$$

denote the feature vectors of the i-th sample in the m-th round training set from Party B and Party C respectively, and

$${ytr}_{i}^{m} ∈ \{ - 1 , 1 \}$$

is its label, i=1, 2, . . . , 2|P|; the remaining unsampled data in the unlabeled sample dataset are used to construct the m-th round prediction set:

$${X}_{test}^{m} = \{ {xte}_{j}^{m} \} ,$$

where

$$x t {e}_{j}^{m}$$

denotes the j-th sample feature vector in round m, j=1, 2, . . . , |U|−|N^{m}|.
S22: using the GBDT algorithm as the base estimator to construct the vertical federated model; training the model on the training dataset

$${X}_{train}^{m}$$

through an ensemble of T decision trees

$${f}_{t}^{m} ;$$

for each sample

$${xtr}_{i}^{m} in {X}_{train}^{m} ,$$

predicting the m-th round output denoted as

$${\hat{y}}_{ι}^{m} = {\sum }_{t = 1}^{T} {f}_{t}^{m} ( {xtr}_{i}^{m} ) ;$$

where T represents the total number of the decision trees in the m-th round,

$${f}_{t}^{m} ( {xtr}_{i}^{m} )$$

denotes the prediction result of the t-th tree in the m-th round,

$${xtr}_{i}^{m}$$

denotes the feature vector of the i-th sample in the m-th round, i=1, 2, . . . , 2|P|; constructing first-order and second-order gradient histograms based on the gradient values of the loss function between the m-th round prediction output

$${\hat{y}}_{ι}^{m}$$

and the true label

$${ytr}_{i}^{m} ;$$

jointly analyzing the gradient histograms of all features from Party B and Party C to determine the global optimal split of the current node so as to construct an optimal decision tree.
S23 using the m-th round, trained GBDT model to perform prediction on the m-th round prediction set

$${X}_{test}^{m}$$

and obtaining the prediction score for each sample

$$x t {e}_{j}^{m}$$

in the prediction set

$${X}_{test}^{m} ;$$

traversing all samples in the unlabeled sample dataset U, identifying the sample xuᵢ in U whose ID is identical to that of

$$xt {e}_{j}^{m} ,$$

and assigning the prediction score of

$$x t {e}_{j}^{m}$$

to xuᵢ as the m-th round prediction score for sample xuᵢ denoted as

$${Oob}_{i}^{m} ,$$

where i=1, . . . , |U| denotes the sample indices in the unlabeled sample dataset U; if a sample xuᵢ in U does not exist in

$${X}_{test}^{m} ,$$

namely, there does not exist a sample xuᵢ in U that shares the same ID as

$$x t {e}_{j}^{m} ,$$

then the corresponding m-th round prediction score

$${Oob}_{i}^{m}$$

for that sample xuᵢ is set to 0.

Further, in step S22, a prediction result [symbol] of each sample

$$x t {r}_{i}^{m}$$

in the m-th round is first initialized, where the prediction result [symbol] is a random value, the federated training process of the t-th tree in the m-th round is as follows:
S221: starting from Party B, calculating for each ample

$$x t {r}_{i}^{m , B}$$

the first-order gradient of the loss function in the m-th round:

$${g}_{i}^{m} = {\partial }_{{\hat{y}}_{{ι}_{( t - 1 )}}^{m}} L ( {ytr}_{i}^{m} , {\hat{y}}_{{ι}_{( t - 1 )}}^{m} ) ,$$

and the second-order gradient:

$${h}_{i}^{m} = {\partial }_{{\hat{y}}_{{ι}_{( t - 1 )}}^{m}}^{2} L ( {ytr}_{i}^{m} , {\hat{y}}_{{ι}_{( t - 1 )}}^{m} ) ,$$

where i=1, 2, . . . , 2|P|, represents the prediction result for the sample

$$x t {r}_{i}^{m}$$

aggregated from the previous t−1 trees in the m-th round

$$y t {r}_{i}^{m}$$

denotes the true label of the i-th sample in the m-th round, and

$$L ( {ytr}_{i}^{m} , {\hat{y}}_{{ι}_{( t - 1 )}}^{m} )$$

is the loss function; performing additive homomorphic encryption on

$${g}_{i}^{m} and {h}_{i}^{m}$$

to obtain

$$〚 {g}_{i}^{m} 〛 and 〚 {h}_{i}^{m} 〛$$

respectively; Party B sends

$$〚 {g}_{i}^{m} 〛 and 〚 {h}_{i}^{m} 〛$$

to Party C.
S222: for Party C, constructing the m-th round gradient histogram based on its feature data, and sending the encrypted gradient histogram to Party B.
S223: Party B decrypting the encrypted gradient histogram of the m-th round received from Party C, enumerating each feature gradient histogram to perform optimal solution calculation based on the split gain formula, identifying the global optimal split point, and returning the split information to Party C for interpretation.
S224: Party C determining feature thresholds based on a feature index Kₒₚₜ and a threshold index Vₒₚₜ received from Party B, and partitions the current sample space accordingly; then Party C locally constructing a lookup table recording the selected feature and threshold in the form of [record ID, feature, threshold], and returning the record ID and the left-side partitioned sample space (I_{L}) to Party B.
S225: Party B partitioning the current node based on the received [record ID, I_{L}] and associating the current node with [party, record ID]; Party B synchronizing the node split information with Party C and proceeding to the next node split.
S226: iterating steps S222 to S225 until the training termination condition or the maximum tree depth is reached.

Future, step S222 specifically comprises the following steps:
S2221: for all features of Party C in the current m-th round samples

$$x t {r}_{i}^{m} ,$$

sorting all the samples based on the feature values of each feature, and then dividing the sorted samples into q buckets, thereby obtaining corresponding feature thresholds:

$${s}_{k , v}^{m} ∈ \{ {s}_{k , 1}^{m} , {s}_{k , 2}^{m} , … , {s}_{k , q}^{m} \}$$

for each category, where k denotes the feature index, and denotes the threshold of the q-th category of the feature index k in the m-th round.
S2222: based on

$$〚 {g}_{i}^{m} 〛 and 〚 {h}_{i}^{m} 〛$$

of the m-th round received from Party B, Party C performs encrypted gradient aggregation to construct the encrypted gradient histogram of the m-th round as follows:

$${G}_{k , v}^{m} = {\sum }_{i ∈ \{ i \vert {s}_{k , v - 1}^{m} \geq {xtr}_{i , k}^{m} > {s}_{k , v}^{m} \}} 〚 {g}_{i}^{m} 〛 , {H}_{k , v}^{m} = {\sum }_{i ∈ \{ i \vert {s}_{k , v}^{m} \geq {xtr}_{i , k}^{m} > {s}_{k , v - 1}^{m} \}} 〚 {h}_{i}^{m} 〛$$

where i=1, 2, . . . , 2|P|, v=1, 2, . . . , q.
S2223: Party C sends

$${G}_{k , v}^{m} and {H}_{k , v}^{m}$$

of the m-th round to Party B.

Further, step S223 specifically comprises the following steps:
S2231: Party B aggregates the first-order and second-order gradients of all samples in the current node space, performing

$${g}^{m} = {\sum }_{i ∈ I} {g}_{i}^{m} , {h}^{m} = {\sum }_{i ∈ I} {h}_{i}^{m} ,$$

where I denotes all samples in the current node.
S2232: Party B decrypts

$${G}_{k , v}^{m} and {H}_{k , v}^{m}$$

of the m-th round received from Party C, obtaining the decrypted values

$$D ( {G}_{k , v}^{m} ) and D ( {H}_{k , v}^{m} )$$

of the m-th round; for each category of every feature from Party C, the following calculations are performed to obtain

$${g}_{l}^{m} , {h}_{l}^{m} , {g}_{r}^{m} and {h}_{r}^{m} :$$

$${g}_{l}^{m} = {g}_{l}^{m} + D ( {G}_{k , v}^{m} ) , {h}_{l}^{m} = {h}_{l}^{m} + D ( {H}_{k , v}^{m} )$$

$${g}_{r}^{m} = {g}^{m} - {g}_{l}^{m} , {h}_{r}^{m} = {h}^{m} - {h}_{l}^{m}$$

where I_{L} denotes the sample space of the left child node after the split, I_{R} denotes the sample space of the right child node after the split,

$${g}_{l}^{m} = {\sum }_{i ∈ {I}_{L}} {g}_{i}^{m}$$

denotes the sum of the first-order gradients of all samples in the left child node sample space in the m-th round,

$${h}_{l}^{m} = {\sum }_{i ∈ {I}_{L}} {h}_{i}^{m}$$

denotes the sum of the second-order gradients of all samples in the left child node sample space in the m-th round,

$${g}_{r}^{m} = {\sum }_{i ∈ {I}_{R}} {g}_{i}^{m}$$

denotes the sum of the first-order gradients of all samples in the right child node sample space in the m-th round,

$${h}_{r}^{m} = {\sum }_{i ∈ {I}_{R}} {h}_{i}^{m}$$

denotes the sum of the second-order gradients of all samples in the right child node sample space in the m-th round.
S2233: calculating the optimal split value of the current node in the m-th round

$${ℒ}_{s plit}^{m} :$$

$${ℒ}_{s plit}^{m} = \frac{1}{2} [ \frac{{( {\sum }_{i ∈ {I}_{L}} {g}_{i}^{m} )}^{2}}{{\sum }_{i ∈ {I}_{L}} {h}_{i}^{m} + λ} + \frac{{( {\sum }_{i ∈ {I}_{R}} {g}_{i}^{m} )}^{2}}{{\sum }_{i ∈ {I}_{R}} {h}_{i}^{m} + λ} + \frac{{( {\sum }_{i ∈ I} {g}_{i}^{m} )}^{2}}{{\sum }_{i ∈ I} {h}_{i}^{m} + λ} ] = \frac{1}{2} [ \frac{{g}_{l}^{{m}^{2}}}{{h}_{l}^{m} + λ} + \frac{{g}_{r}^{{m}^{2}}}{{h}_{r}^{m} + λ} + \frac{{g}^{{m}^{2}}}{{h}^{m} + λ} ] .$$

where λ is a hyperparameter.
S2234 for all threshold values

$${s}_{k , v}^{m}$$

of each feature of the sample, a corresponding optimal split value

$${ℒ}_{s plit}^{m}$$

is obtained; the maximum

$${ℒ}_{split}^{m}$$

among them is selected to determine the corresponding feature threshold as the global optimal split in the m-th round; the global optimal split is represented as [party, feature index (Kₒₚₜ), threshold index (Vₒₚₜ)], and the feature index (Kₒₚₜ) and threshold index (Vₒₚₜ) are returned to Party C.

Further, step S23 specifically comprises the following steps:
S231: Party B queries the record [party, record ID] associated with the current node; based on the record, Party B sends the sample ID to be labeled and the record ID to Party C, and requests the next tree traversal direction, that is, whether to proceed to the left or right child node.
S232: upon receiving the sample ID and record ID, Party C compares the value of the corresponding feature in the sample to be labeled with the threshold recorded in the local lookup table [record ID, feature, threshold], determines the next tree traversal direction, and sends the decision back to Party B.
S233: upon receiving the traversal decision from Party C, Party B proceeds to the corresponding child node.
S234: iterating steps S231 to S233 until a leaf node is reached, and obtaining the classification label and the corresponding weight at that leaf node, thereby determining the m-th round prediction score

$${Oob}_{i}^{m}$$

for the sample xuᵢ in U that corresponds to the sample

$$x t {e}_{j}^{m} :$$

$${Oob}_{i}^{m} = - \frac{{\sum }_{i ∈ I} {g}_{i}^{m}}{{\sum }_{i ∈ I} {h}_{i}^{m} + λ}$$

where I denotes the sample space of the leaf node, and λ is a hyperparameter.

Further, in step S3, the probability of each sample xuᵢ in U being predicted as a positive sample is calculated based on the cumulative sum of its prediction scores over M rounds and the total number of times it appears in the prediction sets of the M rounds; all samples in U are sorted in descending order according to the calculated probability of being a positive sample; based on prior knowledge, the top-ranked samples are selected as reliable positive samples, which are added to the positive sample dataset P and simultaneously removed from U; the step specifically comprises the following sub-steps:
S31: the probability ρᵢ of each sample xuᵢ in U being predicted as a positive sample is calculated based on the cumulative sum of its prediction scores:

$${\sum }_{m = 1}^{M} {Oob}_{i}^{m}$$

over M rounds and the total number of times it appears in the prediction sets of the M rounds, using the following formula:

$${ρ}_{i} = \frac{{\sum }_{m = 1}^{M} {Oob}_{i}^{m}}{{\sum }_{m = 1}^{M} I ( {xu}_{i} ∈ {X}_{test}^{m} )}$$

where

$$I ( {xu}_{i} ∈ {X}_{test}^{m} )$$

is an indicator function, such that I=1 if the sample xuᵢ in U appears in the prediction set

$${X}_{test}^{m}$$

of the m-th round, and I=0 otherwise;
S32: sorting all samples in U in descending order according to their calculated probabilities ρᵢ, selecting the top θ ranked samples as reliable positive samples, adding them to the positive sample dataset P, and simultaneously removing them from U, where the value of θ is determined based on prior knowledge.

Further, step S4 specifically comprises iteratively performing steps S2 to S3 until a preset maximum number of iterations is reached. In each iteration, to ensure the reliability and accuracy of the recommendations, only a limited number of reliable positive samples are selected. Consequently, multiple iterations are required to accumulate a sufficient number of reliable positive samples for batch recommendation. Specifically, in each iteration, step S3 selects a portion of reliable positive samples from the unlabeled dataset U, adds them to the positive sample dataset P, and simultaneously removes them from U. Through this iterative process, the size of |P| gradually increases while the size of |U| correspondingly decreases, until the preset maximum number of iterations is reached. The aggregate set of reliable positive samples extracted from U across all iterations may then be regarded as potential purchasers of financial products, who can be accurately recommended in batch to the financial product provider.

Advantageous Effects of the Invention: The present invention addresses the challenge that a financial product provider typically has access only to positively labeled samples, thereby limiting the effectiveness of recommendation systems. By combining vertical federated learning with semi-supervised learning, the invention enables collaborative training and prediction across multiple parties while preserving data privacy and security. This approach allows for batch recommendation in environments where only limited positive samples are available alongside a large volume of unlabeled data. Accordingly, the invention improves the reliability of recommendations and facilitates accurate and scalable identification of potential users for financial products.

Other advantages, objectives, and features of the present invention will, to some extent, be explained in the following description, and to some extent, will become apparent to those skilled in the art upon examination of the following or through the practice of the invention. The objectives and other advantages of the invention may be realized and attained by means of the elements and combinations particularly pointed out in the claims.

### BRIEF DESCRIPTION OF THE DRAWINGS

In order to make the objectives, technical solutions, and advantages of the present invention more apparent, preferred embodiments of the invention are described in detail below with reference to the accompanying drawings, in which:

FIG. 1 is a flow diagram of a method for recommending financial products to potential users based on multi-party semi-supervised learning;

FIG. 2 is a schematic diagram of sample alignment among multi-party data in vertical federated learning;

FIG. 3 is a schematic diagram illustrating the construction of training and testing sets by random sampling;

FIG. 4 is a schematic diagram illustrating the construction of gradient histograms;

FIG. 5 is a schematic diagram showing the training process of a vertical federated GBDT model;

FIG. 6 is a schematic diagram showing the prediction process of a vertical federated GBDT model.

### DETAILED DESCRIPTION OF THE INVENTION

The following embodiments illustrate the implementation of the present invention through specific examples. Other advantages and effects of the invention can be readily understood by those skilled in the art based on the content disclosed in this specification. The invention may also be implemented or applied in other specific forms. The details disclosed herein may be modified or altered in various ways without departing from the spirit of the invention, depending on particular applications and interpretations. It should be noted that the drawings provided in the following embodiments are for illustrative purposes only and are intended to explain the basic concept of the invention. Where there is no conflict, the features of the embodiments may be combined with one another.

The drawings are intended for illustrative purposes only and are schematic rather than physical representations. They should not be construed as limiting the invention. Certain parts in the drawings may be omitted, enlarged, or reduced for clarity, and do not represent the actual size of the product. It is understood by those skilled in the art that some known structures and their descriptions may be omitted in the drawings.

Identical or similar reference numerals in the drawings of the embodiments correspond to identical or similar components. In the description of the present invention, it should be understood that positional or directional terms such as “upper”, “lower”, “left”, “right”, “front”, and “rear” are based on the orientations shown in the drawings. They are used merely for convenience of description and simplification, and are not intended to limit the structure or operation of the components to specific orientations. The actual meaning of such terms should be interpreted flexibly by those skilled in the art according to specific contexts.

An illustrative application of the present invention pertains to the recommendation of housing provident fund contributions for flexible employees. In this scenario, information concerning individuals who have not yet participated in the housing provident fund system is dispersed across multiple parties, each operating under stringent data privacy and security regulations. By leveraging vertical federated learning, sample alignment is performed across multiple parties, Party A retains information associated with flexible employees who have already contributed to the housing provident fund, while Parties B and C possess data that include both contributors and individuals who have not yet contributed.

In this embodiment: Party A represents the housing provident fund authority and maintains contribution-related data for flexible employees. Such data may include, but are not limited to, personal demographic information, housing provident fund account identifiers, account balances, contribution periods, applicable contribution ratios, contribution amounts, and other associated attributes. Optionally, Party B may correspond to a tax authority and possess data including personal identity information, individual income tax records, property tax records, and related financial information. Optionally, Party C may represent a social security authority and retain personal demographic data alongside records pertaining to medical insurance, pension insurance, unemployment insurance, and other forms of social security coverage.

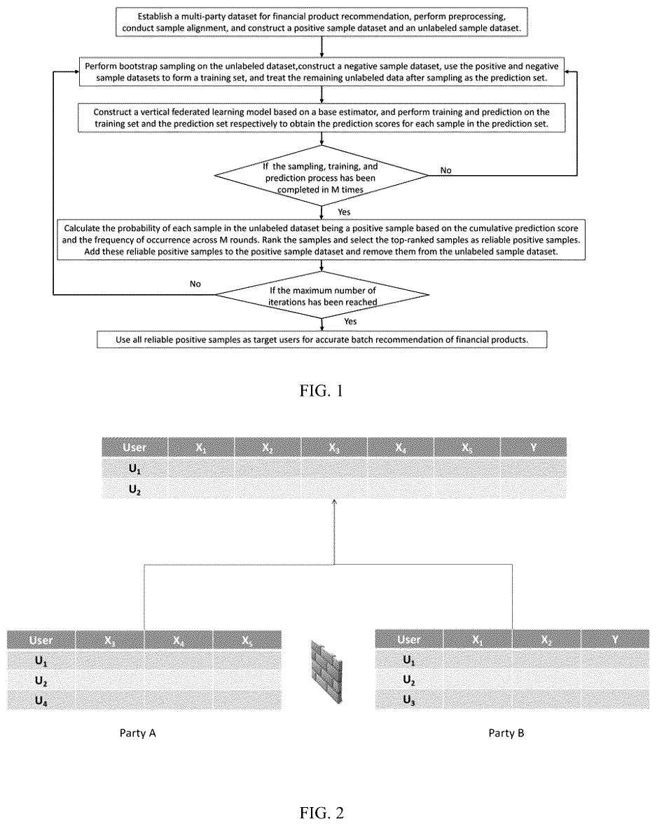

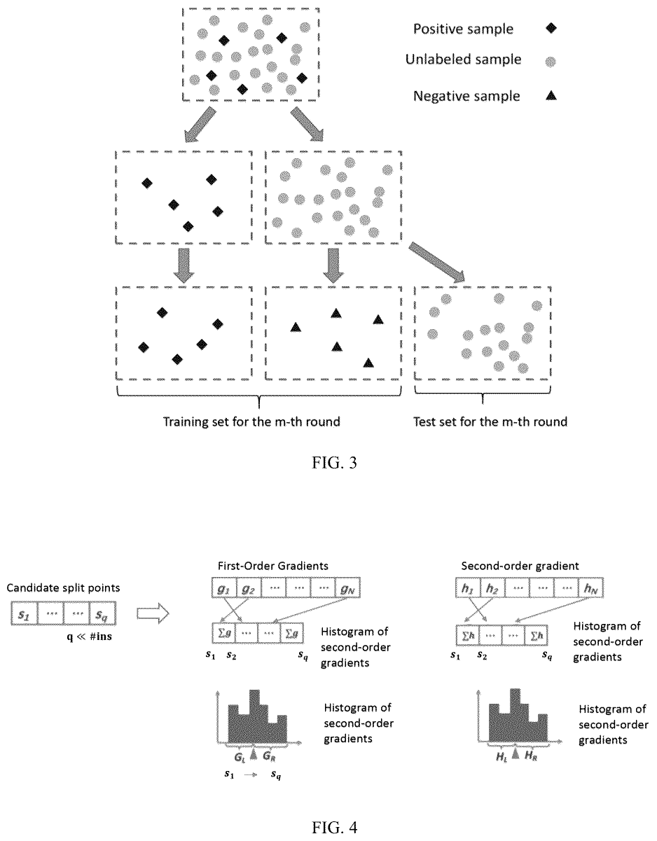

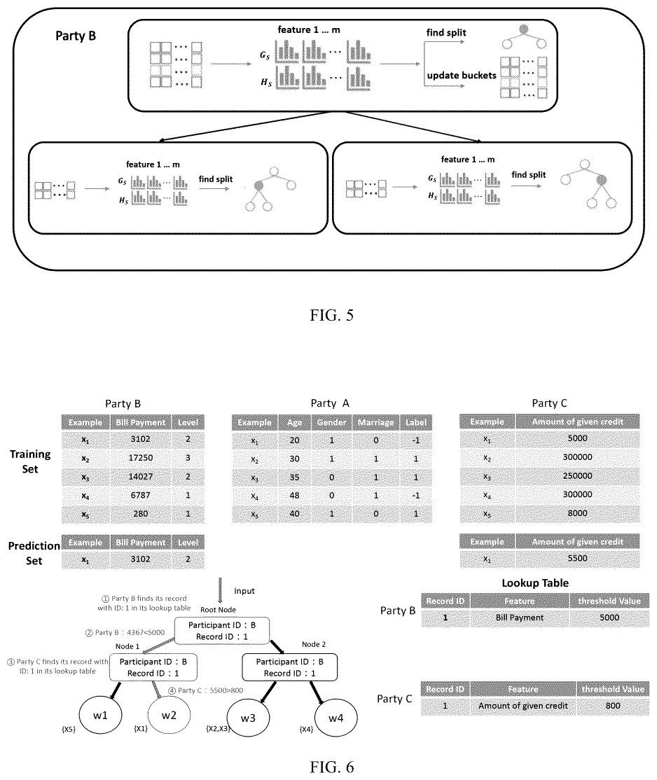

Referring to FIG. 1 to FIG. 6, a method for recommending financial products to potential users based on multi-party semi-supervised learning is provided, comprising the following steps:
S1: constructing a multi-party dataset for recommending provident fund contributions for flexible employees. The dataset comprises Party A, which holds contribution information of flexible employees, as well as Parties B and C. The dataset is subjected to preprocessing and sample alignment, resulting in the formation of a positive sample dataset P and an unlabeled sample dataset U. The specific steps are as follows:
S11: performing data preprocessing on the multi-party dataset for recommending housing provident fund contributions for flexible employees, including processing of redundant data, handling of missing values, treatment of outliers, data normalization, and label data processing, to obtain: the dataset of Party A, denoted as

$${D}_{A} = \{ ( {x}_{i}^{A} , {y}_{i}^{A} ) \} ,$$

where

$${x}_{i}^{A}$$

represents the feature vector or the i-th sample of Party A, with a vector dimension denoted as d_{A}, and

$${y}_{i}^{A} ∈ \{ 1 \}$$

denotes the corresponding label of

$${x}_{i}^{A} ,$$

i=1, . . . a; the dataset of Party B, denoted as

$${D}_{B} = \{ ( {x}_{i}^{B} , {y}_{i}^{B} ) \} ,$$

where

$${x}_{i}^{B}$$

represents the feature vector of the i-th sample of Party B, with a vector dimension denoted as d_{B}, and

$${y}_{i}^{B} ∈ \{ 0 \}$$

denotes the corresponding label of

$${x}_{i}^{B} ,$$

i=1, . . . , b; the dataset of Party C, denoted as

$${D}_{C} = \{ ( {x}_{i}^{C} , {y}_{i}^{C} ) \} ,$$

where

$${x}_{i}^{C}$$

represents the feature vector of the i-th sample of Party C, with a vector dimension denoted as d_{C}, and

$${y}_{i}^{C} ∈ \{ 0 \}$$

denotes the corresponding label of

$${x}_{i}^{C} ,$$

i=1, . . . , c; The specific operations for data preprocessing are as follows:

Redundant data processing specifically comprises: determining whether data records are duplicated by examining certain fields within each record, retaining only a single instance of each duplicated data record, and removing the remaining duplicates from the dataset, while preserving a backup of the original data to allow for retrospective and comparative analysis when needed.

The handling of missing values specifically comprises calculating a missing rate for each feature in the data, treating any data record with a number of missing features exceeding half of the total feature dimension as invalid data, and removing such invalid data from the dataset; the remaining incomplete data are imputed using specific methods selected according to the data distribution. Optionally, the median value may be used to fill in missing values.

Outlier detection and treatment specifically comprises: determining threshold values for outliers based on actual conditions; optionally, using the standard deviation method to identify outlier range; optionally, using box plots to visualize and detect values exceeding the threshold; optionally, replacing outliers with the median. After processing outliers, the dataset is rechecked to ensure the outliers have been addressed and the fundamental characteristics of the dataset remain unchanged.

Data normalization specifically comprises classifying existing features into continuous features and categorical features according to their data types; optionally, applying min-max normalization to continuous features, and applying one-hot encoding to categorical features.

Label data processing specifically comprises adding a label column to the dataset of Party A, with the label value set to “1” to represent positive samples; adding a label column to each of the dataset of Party B and the dataset of Party C, with the label value set to “0” to represent unlabeled samples.
S12: Performing encrypted sample alignment between the dataset of Party B and the dataset of Party C based on their sample IDs; retaining the sample data resulting from the encrypted alignment between Party B and Party C, and discarding the unaligned sample data, so as to obtain n aligned samples; an aligned dataset of Party B is denoted as

$${D}_{A l i g n}^{B} = \{ ( {x}_{i}^{B} , {y}_{i}^{B} ) \} ,$$

and an aligned dataset of Party C is denoted as

$${D}_{A l i g n}^{C} = \{ ( {x}_{i}^{C} , {y}_{i}^{C} ) \} ; {y}_{i}^{B} ∈ \{ 0 \}$$

represents the corresponding label of

$${x}_{i}^{B} and {y}_{i}^{C} ∈ \{ 0 \}$$

represents the corresponding label of

$${x}_{i}^{C} ,$$

where i=1, . . . , n.

Optionally, sample encryption and alignment may be performed using an RSA-based algorithm and hash functions.
S13: performing encrypted sample alignment between the dataset of Party A, the aligned dataset of Party B and the aligned dataset of Party C based on their sample IDs; the aligned samples from all three parties are used as positive samples to construct the positive sample dataset: P={(xpᵢ, ypᵢ)}, where

$${xp}_{i} = ( {xp}_{i}^{A} , {xp}_{i}^{B} , {xp}_{i}^{C} ) , {xp}_{i}^{A} , {xp}_{i}^{B} and {xp}_{i}^{C}$$

represent the aligned feature vectors of the i-th sample from Party A, Party B, and Party C, respectively, ypᵢ∈{1} denotes the positive sample label, and |P| is the number of positive samples, i=1, . . . , |P|; the samples not jointly aligned among the three parties are considered unlabeled samples and used to construct the unlabeled sample dataset: U={(xuᵢ, yuᵢ)}, where

$$x {u}_{i} = ( x {u}_{i}^{B} , {xu}_{i}^{C} ) , and {xu}_{i}^{B} and {xu}_{i}^{C}$$

represent the aligned feature vectors of the i-th sample from Party B and Party C, respectively, yuᵢ∈{0} denotes the unlabeled sample label, and |U| is the number of the unlabeled samples, i=1, . . . , |U|.

Optionally, an RSA-based algorithm and hash functions may be used to perform encrypted sample alignment.
S2: Establishing a candidate recommendation process for predicting the unlabeled samples, and iteratively executing the candidate recommendation process until M rounds are completed. Optionally, the total number of iterations M may be set to 10. Wherein the m-th round of the candidate recommendation process is as follows: randomly sampling with replacement a total of |P| samples from the unlabeled sample dataset U, where |P| denotes the number of samples in P, using the |P| samples to form a negative sample dataset: N^{m}; constructing a training dataset using P and N^{m}:

$${X}_{train}^{m} ,$$

constructing a prediction dataset

$${X}_{test}^{m}$$

using the unsampled samples from U; constructing a vertical federated learning model using Gradient Boosting Decision Tree (GBDT) as the base estimator and training the model on

$${X}_{train}^{m} ;$$

performing prediction on

$${X}_{test}^{m}$$

by inputting it into the trained vertical federated model to obtain a score as the prediction score for each sample in

$${X}_{test}^{m} .$$

S21: Using bootstrap sampling to randomly sample with replacement |P| samples from the unlabeled sample dataset U to construct the m-th round negative sample dataset:

$${N}^{m} = \{ ( x {n}_{i}^{m} , {yn}_{i}^{m} ) \} ,$$

where

$$x {n}_{i}^{m} = ( x {n}_{i}^{m , B} \cdot {xn}_{i}^{m , C} ) ,$$

$${xn}_{i}^{m , B} and {xn}_{i}^{m , C}$$

represent the feature vectors of the i-th negative sample in round m from Party B and Party C respectively, and

$${yn}_{i}^{m} ∈ \{ - 1 \}$$

denotes the corresponding label, i=1, 2, . . . , 2|P|; |N^{m}| denotes the number of samples in the m-th round negative sample dataset N^{m}; the positive sample dataset P and the negative sample dataset N^{m} are used to construct the m-th round training set:

$${X}_{train}^{m} = \{ ( {xtr}_{i}^{m} , {ytr}_{i}^{m} ) \} ,$$

where

$${xtr}_{i}^{m} = ( {xtr}_{i}^{m , B} , {xtr}_{i}^{m , C} ) ; {xtr}_{i}^{m , B} and {xtr}_{i}^{m , C}$$

denote the feature vectors of the i-th sample in the m-th round training set from Party B and Party C respectively, and

$${ytr}_{i}^{m} ∈ \{ - 1 , 1 \}$$

is its label, i=1, 2, . . . , 2|P|; the remaining unsampled data in the unlabeled sample dataset are used to construct the m-th round prediction set:

$${X}_{test}^{m} = \{ {xte}_{j}^{m} \} ,$$

where

$${xte}_{j}^{m}$$

denote the j-th sample feature vector in round m, j=1, 2, . . . , |U|−|N^{m}|.
S22: using the GBDT algorithm as the base estimator to construct the vertical federated model and performing training on the training dataset

$${X}_{train}^{m}$$

through an ensemble of T decision trees

$${f}_{t}^{m} .$$

For each sample

$${xtr}_{i}^{m} in {X}_{train}^{m} ,$$

predicting the m-th round output denoted as

$${\hat{y}}_{ι}^{m} = {\sum }_{t = 1}^{T} {f}_{t}^{m} ( {xtr}_{i}^{m} ) ;$$

where T represents the total number of the decision trees in the m-th round,

$${f}_{t}^{m} ( {xtr}_{i}^{m} )$$

denotes the prediction result of the t-th tree in the m-th round,

$${xtr}_{i}^{m}$$

denotes the feature vector of the i-th sample in the m-th round, i=1, 2, . . . , 2|P|. Optionally, the total number of decision trees T may be set to 40. Constructing first-order and second-order gradient histograms based on the gradient values of the loss function between the m-th round prediction output

$${\hat{y}}_{ι}^{m}$$

and the true label

$${ytr}_{i}^{m} .$$

Jointly analyzing the gradient histograms of all features from Party B and Party C to determine the global optimal split of the current node so as to construct an optimal decision tree.

The prediction result

$${\hat{y}}_{{ι}_{( 0 )}}^{m}$$

of each sample

$$x t {r}_{i}^{m}$$

in the m-th round is first initialized, where the prediction result

$${\hat{y}}_{{ι}_{( 0 )}}^{m}$$

is a random value. Optionally, the random value of

$${\hat{y}}_{{ι}_{( 0 )}}^{m}$$

may be either −1 or 1. The federated training process of the t-th tree in the m-th round is as follows:
S221: Starting from Party B, calculating for each sample

$$x t {r}_{i}^{m , B}$$

the first-order gradient of the loss function in the m-th round:

$${g}_{i}^{m} = {ϑ}_{{\hat{y}}_{{ι}_{( t - 1 )}}^{m}} L ( {ytr}_{i}^{m} , {\hat{y}}_{{ι}_{( t - 1 )}}^{m} ) ,$$

and the second-order gradient:

$${h}_{i}^{m} = {ϑ}_{{\hat{y}}_{{ι}_{( t - 1 )}}^{m}}^{2} L ( {ytr}_{i}^{m} , {\hat{y}}_{{ι}_{( t - 1 )}}^{m} ) ,$$

where i=1, 2, . . . , 2|P|, represents the prediction result for the sample

$${xtr}_{i}^{m}$$

aggregated from the previous t−1 trees in the m-th round,

$${ytr}_{i}^{m}$$

denotes the true label of the i-th sample in the m-th round, and

$$L ( {ytr}_{i}^{m} , {\hat{y}}_{{ι}_{( t - 1 )}}^{m} )$$

is the loss function; performing additive homomorphic encryption on

$${g}_{i}^{m}$$

$$and$$

$${h}_{i}^{m}$$

to obtain

$$\text{?} {g}_{i}^{m} \text{?}$$

$$and$$

$$\text{?} {h}_{i}^{m} \text{?}$$

respectively; Party B sends

$$〚 {g}_{i}^{m} 〛$$

$$and$$

$$〚 {h}_{i}^{m} 〛$$

to Party C.

Optionally, the loss function used herein is the mean squared error (MSE), and the homomorphic encryption scheme adopted is the Paillier homomorphic encryption. The notation [symbol] a [symbol] is used to represent the homomorphic encryption of data a.
S222: For Party C, constructing the m-th round gradient histogram based on its feature data, and sending the encrypted gradient histogram to Party B.
S2221: for all features of Party C in the current m-th round samples

$${xtr}_{i}^{m} ,$$

sorting all the samples based on the feature values of each feature, and then dividing the sorted samples into q buckets, thereby obtaining the corresponding feature thresholds:

$${s}_{k , v}^{m} , ∈ \{ {s}_{k , 1}^{m} , {s}_{k , 2}^{m} , … , {s}_{k , q}^{m} \}$$

for each category, where k denotes the feature index, and

$${s}_{k , q}^{m}$$

denotes the threshold of the q-th category of the feature index k in the m-th round; Optionally, the number of categories q may be set to 10.
S2222: Based on

$$〚 {g}_{i}^{m} 〛 and 〚 {h}_{i}^{m} 〛$$

of the m-th round received from Party B, Party C performs encrypted gradient aggregation to construct the encrypted gradient histogram of the m-th round as follows:

$${G}_{k , v}^{m} = {\sum }_{i ∈ \{ i \vert {s}_{k , v - 1}^{m} \geq {xtr}_{i , k}^{m} > {s}_{k , v}^{m} \}} 〚 {g}_{i}^{m} 〛 , {H}_{k , v}^{m} = {\sum }_{i ∈ \{ i \vert {s}_{k , v}^{m} \geq {xtr}_{i , k}^{m} > {s}_{k , v - 1}^{m} \}} 〚 {h}_{i}^{m} 〛$$

where i=1, 2, . . . , 2|P|, v=1, 2, . . . , q.
S2223: Party C sends

$${G}_{k , v}^{m} and {H}_{k , v}^{m}$$

of the m-th round to Party B.
S223: Party B decrypts the encrypted gradient histogram of the m-th round received from Party C, enumerates each feature gradient histogram to perform optimal solution calculation based on the split gain formula, identifies the global optimal split point, and returns the split information to Party C for interpretation. The specific process is as follows:
S2231: Party B aggregates the first-order and second-order gradients of all samples in the current node space, performing

$${g}^{m} = {\sum }_{i ∈ I} {g}_{i}^{m} , {h}^{m} = {\sum }_{i ∈ I} {h}_{i}^{m} ,$$

where I denotes all samples in the current node.
S2232: Party B decrypts

$${G}_{k , v}^{m} and {H}_{k , v}^{m}$$

of the m-th round received from Party C, obtaining the decrypted values

$$D ( {G}_{k , v}^{m} ) and D ( {H}_{k , v}^{m} )$$

of the m-th round; for each category of every feature from Party C, the following calculations are performed to obtain

$${g}_{l}^{m} , {h}_{l}^{m} , {g}_{r}^{m} and {h}_{r}^{m} :$$

$${g}_{l}^{m} = {g}_{l}^{m} + D ( {G}_{k , v}^{m} ) , {h}_{l}^{m} = {h}_{l}^{m} + D ( {H}_{k , v}^{m} )$$

$${g}_{r}^{m} = {g}^{m} - {g}_{l}^{m} , {h}_{r}^{m} = {h}^{m} - {h}_{l}^{m}$$

where I_{L} denotes the sample space of the left child node after the split, I_{R} denotes the sample space of the right child node after the split,

$${g}_{l}^{m} = {\sum }_{i ∈ {I}_{L}} {g}_{i}^{m}$$

denotes the sum of the first-order gradients of all samples in the left child node sample space in the m-th round,

$${h}_{l}^{m} = {\sum }_{i ∈ {I}_{L}} {h}_{i}^{m}$$

denotes the sum of the second-order gradients of all samples in the left child node sample space in the m-th round,

$${g}_{r}^{m} = {\sum }_{i ∈ {I}_{R}} {g}_{i}^{m}$$

denotes the sum of the first-order gradients of all samples in the right child node sample space in the m-th round,

$${h}_{r}^{m} = {\sum }_{i ∈ {I}_{R}} {h}_{i}^{m}$$

denotes the sum of the second-order gradients of all samples in the right child node sample space in the m-th round.
S2233: calculating the optimal split value of the current node in the m-th round

$${ℒ}_{split}^{m} :$$

$${ℒ}_{split}^{m} = \frac{1}{2} [ \frac{{( {\sum }_{i ∈ {I}_{L}} {g}_{i}^{m} )}^{2}}{{\sum }_{i ∈ {I}_{L}} {h}_{i}^{m} + λ} + \frac{{( {\sum }_{i ∈ {I}_{R}} {g}_{i}^{m} )}^{2}}{{\sum }_{i ∈ {I}_{R}} {h}_{i}^{m} + λ} + \frac{{( {\sum }_{i ∈ I} {g}_{i}^{m} )}^{2}}{{\sum }_{i ∈ I} {h}_{i}^{m} + λ} ] = \frac{1}{2} [ \frac{{g}_{l}^{{m}^{2}}}{{h}_{l}^{m} + λ} + \frac{{g}_{r}^{{m}^{2}}}{{h}_{r}^{m} + λ} + \frac{{g}^{{m}^{2}}}{{h}^{m} + λ} ]$$

where λ is a hyperparameter. Optionally, the hyperparameter λ may be set to 0.5.
S2234: for all threshold values

$${s}_{k , v}^{m}$$

of each feature of the sample, a corresponding optimal split value

$${ℒ}_{split}^{m}$$

is obtained; the maximum

$${ℒ}_{split}^{m}$$

among them is selected to determine the corresponding feature threshold as the global optimal split in the m-th round; the global optimal split is represented as [party, feature index (Kₒₚₜ), threshold index (Vₒₚₜ)], and the feature index (Kₒₚₜ) and threshold index (Vₒₚₜ) are returned to Party C.
S224: Party C determines a feature threshold based on a feature index Kₒₚₜ and a threshold index Vₒₚₜ received from Party B, and partitions the current sample space accordingly; then Party C locally constructs a lookup table recording the feature threshold in the form of [record ID, feature, threshold], and returns the record ID and the left-side partitioned sample space (I_{L}) to Party B.
S225: Party B partitions the current node based on the received [record ID, I_{L}] and associates the current node with [party, record ID]; Party B synchronizes the node split information with Party C and proceeds to the next node split.
S226: iterating steps S222 to S225 until the training termination condition or the maximum tree depth is reached.
S23: using the m-th round, trained GBDT model to perform prediction on the m-th round prediction set

$${X}_{test}^{m}$$

and obtaining the prediction score for each sample

$${xte}_{j}^{m}$$

in the prediction set

$${X}_{test}^{m} ;$$

traversing all samples in the unlabeled sample dataset U, identifying the sample xuᵢ in U whose ID is identical to that of

$$x t {e}_{j}^{m} ,$$

and assigning the prediction score of

$$x t {e}_{j}^{m} ,$$

to xuᵢ as the m-th round prediction score of sample xuᵢ denoted as

$${Oob}_{i}^{m} ,$$

where i=1, . . . , |U| denotes the sample indices in the unlabeled sample dataset U. If a sample xuᵢ in U does not exist in

$${X}_{test}^{m} ,$$

then the corresponding m-th round prediction score

$${Oob}_{i}^{m}$$

for that sample xuᵢ is set to 0. The specific process is as follows:
S231: Party B queries the record [party, record ID] associated with the current node; based on the record, Party B sends the sample ID requiring labeling, along with the corresponding record ID to Party C, and requests the next tree traversal direction, that is, whether to proceed to the left or the right child node.
S232: upon receiving the to-be-labeled sample ID and record ID, Party C compares the value of the corresponding feature in the sample to-be-labeled with the threshold recorded in the local lookup table [record ID, feature, threshold], determines the next tree traversal direction, and sends the decision back to Party B.
S233: upon receiving the traversal decision from Party C, Party B proceeds to the corresponding child node.
S234: iterating steps S231 to S233 until a leaf node is reached, and obtaining a classification label and a corresponding weight at that leaf node, thereby determining the m-th round prediction score

$${Oob}_{i}^{m}$$

for the sample xuᵢ in U that corresponds to the sample

$$x t {e}_{j}^{m} :$$

$${Oob}_{i}^{m} = - \frac{{\sum }_{i ∈ I} {g}_{i}^{m}}{{\sum }_{i ∈ I} {h}_{i}^{m} + λ}$$

where I denotes the sample space of the leaf node, and λ is a hyperparameter. Optionally, the hyperparameter λ may be set to 0.5.
S3: The probability of each sample xuᵢ in U being predicted as a positive sample is calculated based on the cumulative sum of its prediction scores over M rounds and the total number of times it appears in the prediction sets of the M rounds. All samples in U are sorted in descending order according to the calculated probability of being a positive sample; based on prior knowledge, the top-ranked samples are selected as reliable positive samples, which are added to the positive sample dataset P and simultaneously removed from U. Optionally, M may be set to 10.
S31: The probability ρᵢ of each sample xuᵢ in U being predicted as a positive sample is calculated based on the cumulative sum of its prediction scores:

$${\sum }_{m = 1}^{M} {Oob}_{i}^{m}$$

over M rounds and the total number of times it appears in the prediction sets of the M rounds, using the following formula:

$${ρ}_{i} = \frac{{\sum }_{m = 1}^{M} {Oob}_{i}^{m}}{{\sum }_{m = 1}^{M} I ( {xu}_{i} ∈ {X}_{test}^{m} )}$$

where

$$I ( {xu}_{i} ∈ {X}_{test}^{m} )$$

is an indicator function, such that I=1 if the sample xuᵢ in U appears in the prediction set

$${X}_{test}^{m}$$

of the m-th round, and I=0 otherwise.
S32: sorting all samples in U in descending order according to their calculated probabilities ρ_i, selecting the top θ ranked samples as reliable positive samples, adding them to the positive sample dataset P, and simultaneously removing them from U, where the value of θ is determined based on prior knowledge. Optionally, θ may be set to 0.1.
S4: Iteratively performing steps S2 to S3 until a preset maximum number of iterations is reached. Optionally, the maximum number of iterations may be set to 5. In each iteration, to ensure the reliability and accuracy of the recommendations, only a limited number of reliable positive samples are selected. Consequently, multiple iterations are required to accumulate a sufficient number of reliable positive samples for batch recommendation. Specifically, in each iteration, step S3 selects a portion of reliable positive samples from the unlabeled dataset U, adds them to the positive sample dataset P, and simultaneously removes them from U. Through this iterative process, the size of |P| gradually increases while the size of IUI correspondingly decreases, until the preset maximum number of iterations is reached. The aggregate set of reliable positive samples extracted from U across all iterations may then be regarded as potential contributors to the housing provident fund, who can be accurately recommended in batch to the housing provident fund authority.

For example, a batch of clients may have relevant information such as personal demographic data, individual income tax records, and property-related tax records in the tax data of Party B, and personal demographic data, medical insurance, pension insurance, and unemployment insurance in the social security data of Party C. After preprocessing, the data is input into a pre-trained vertical federated GBDT model, respectively. Each Party evaluates whether this batch of clients includes potential flexible employees who may contribute to the housing provident fund, based on the respective feature characteristics. Clients identifies as potential contributors are then batch recommended to the housing provident fund authority.

It is to be finally noted that the above embodiments are provided only for illustrating the technical solutions of the present invention, and not intended to limit the scope thereof. Although the present invention has been described in detail with reference to preferred embodiments, those skilled in the art will understand that various modifications and equivalent substitutions may be made to the technical solutions without departing from the spirit and scope of the invention. Such modifications and substitutions shall fall within the scope of protection defined by the appended claims.

1. A multi-party semi-supervised learning method for recommending potential users of financial products, comprising the following steps:
S1: constructing a multi-party dataset for recommending potential users to a financial product; the dataset comprising information of users who have purchased the financial product and users information from other parties; preprocessing the dataset and performing sample alignment to construct a positive sample dataset and an unlabeled sample dataset;
S2: performing random sampling with replacement on the unlabeled sample dataset to construct a negative sample dataset; constructing a training set using the negative sample dataset and the positive sample dataset; constructing a prediction set using unsampled data from the unlabeled sample dataset; constructing a vertical federated learning model based on a base estimator, training the model on the training set and performing prediction on the prediction set, and then obtaining a prediction score for each sample in the prediction set;
S3: repeating the sampling, training, and prediction processes of step S2 multiple times; calculating a probability of each sample in the unlabeled sample dataset being positive, based on a cumulative prediction score and a number of times it appeared in the prediction sets; ranking all samples in the unlabeled sample dataset in descending order according to the probability of being positive; selecting the top-ranked samples as reliable positive samples according to prior knowledge; adding the reliable positive samples to the positive sample dataset; and simultaneously removing the reliable positive samples from the unlabeled sample dataset;
S4: repeating steps S2 to S3 until a preset maximum number of iterations is reached, whereby all reliable positive samples identified from the unlabeled sample dataset are designated as potential users of the financial product, such that accurate and scalable batch recommendations can be provided to financial product providers based on the designated potential users.

2. The multi-party semi-supervised learning method for recommending potential users of financial products according to claim 1, wherein the multi-party dataset for recommending potential users of the financial product in step S1 comprises Party A who holds the information of users that have purchased the financial product, and further comprises Party B and Party C as additional data sources distinct from Party A; step S1 specifically comprises the following steps:
S11: performing data preprocessing on the multi-party dataset for recommending potential users of the financial product, including processing of redundant data, handling of missing values, treatment of outliers, data normalization, and label data processing, to obtain a dataset of Party A:
$${D}_{A} = \{ ( {x}_{i}^{A} , {y}_{i}^{A} ) \} ,$$
wherein
$${x}_{i}^{A}$$
denotes a feature vector of an i-th sample from Party A, d_{A} denotes a vector dimension of
$${x}_{i}^{A} , and {y}_{i}^{A} ∈ \{ 1 \}$$
denotes a corresponding label of
$${x}_{i}^{A} ,$$
where i=1, . . . a; a dataset of Party B:
$${D}_{B} = \{ ( {x}_{i}^{B} , {y}_{i}^{B} ) \} ,$$
wherein
$${x}_{i}^{B}$$
denotes a feature vector of the i-th sample from Party B, d_{B} denotes a vector dimension of
$${x}_{i}^{B} , and {y}_{i}^{B} ∈ \{ 0 \}$$
denotes a corresponding label of
$${x}_{i}^{B} ,$$
where i=1, . . . , b, a dataset of Party C:
$${D}_{C} = \{ ( {x}_{i}^{C} , {y}_{i}^{C} ) \} ,$$
wherein
$${x}_{i}^{C}$$
denotes a feature vector of an i-th sample from Party C, d_{C} denotes a vector dimension of
$${x}_{i}^{C} , and {y}_{i}^{C} ∈ \{ 0 \}$$
denotes a corresponding label of
$${x}_{i}^{C} ,$$
where i=1, . . . , c;
S12: performing encrypted sample alignment between the dataset of Party B and the dataset of Party C based on their sample IDs; retaining the sample data resulting from the encrypted alignment between Party B and Party C, and discarding the unaligned sample data, so as to obtain n aligned samples; an aligned dataset of Party B is denoted as
$${D}_{Align}^{B} = \{ ( {x}_{i}^{B} , {y}_{i}^{B} ) \} ,$$
and an aligned dataset of Party C is denoted as
$${D}_{Align}^{C} = \{ ( {x}_{i}^{C} , {y}_{i}^{C} ) \} ; {y}_{i}^{B} ∈ \{ 0 \}$$
represents the corresponding label of
$${x}_{i}^{B} , and {y}_{i}^{C} ∈ \{ 0 \}$$
represents the corresponding label of
$${x}_{i}^{C} ,$$
where i=1, . . . , n;
S13: performing encrypted sample alignment between the dataset of Party A, the aligned dataset of Party B and the aligned dataset of Party C based on their sample IDs; the aligned samples from all three parties are used as positive samples to construct the positive sample dataset: P={(xpᵢ, ypᵢ)}, where
$${xp}_{i} = ( {xp}_{i}^{A} , {xp}_{i}^{B} , {xp}_{i}^{C} ) , {xp}_{i}^{A} , {xp}_{i}^{B} and {xp}_{i}^{C}$$
represent the aligned feature vectors of the i-th sample from Party A, Party B, and Party C, respectively, ypᵢ∈{1} denotes the positive sample label, and |P| is the number of positive samples, i=1, . . . , |P|; the samples not jointly aligned among the three parties are considered unlabeled samples and used to construct the unlabeled sample dataset: U={(xuᵢ, yuᵢ)}, where
$${xu}_{i} = ( {xu}_{i}^{B} , {xu}_{i}^{C} ) , and {xu}_{i}^{B} and {xu}_{i}^{C}$$
represent the aligned feature vectors of the i-th sample from Party B and Party C, respectively, yuᵢ∈{0} denotes the unlabeled sample label, and |U| is the number of the unlabeled samples, i=1, . . . , |U|.

3. The multi-party semi-supervised learning method for recommending potential users of financial products according to claim 2, characterized in that, in step S11, the processing of redundant data specifically comprises determining whether data records are duplicated by examining certain fields within each record, retaining only a single instance of each duplicated data record, and removing the remaining duplicates from the dataset, while preserving a backup of the original data to allow for retrospective and comparative analysis when needed;
the handling of missing values specifically comprises calculating a missing rate for each feature in the data, treating any data record with a number of missing features exceeding half of the total feature dimension as invalid data, and removing such invalid data from the dataset; the remaining incomplete data are imputed using specific methods selected according to the data distribution;
the treatment of outliers specifically comprises determining threshold values for outliers based on actual business or data conditions; performing visual data analysis to identify data points exceeding the threshold; processing the identified outliers accordingly; and rechecking the dataset post-processing to ensure that all outliers have been handled and that the fundamental statistical characteristics of the dataset remain substantially unchanged;
the data normalization specifically comprises classifying existing features into continuous features and discrete features based on data types; applying min-max normalization to the continuous features, and applying one-hot encoding to the discrete features;
the label data processing specifically comprises adding a label column to the dataset of Party A and assigning a label value of “1” to represent positive sample data; and respectively adding a label column to the datasets of Party B and Party C with a label value of “0” to represent unlabeled data.

4. The multi-party semi-supervised learning method for recommending potential users of financial products according to claim 3, characterized in that step S2 specifically comprises: establishing a candidate recommendation process for predicting the unlabeled samples, and iteratively executing the candidate recommendation process until M rounds are completed, wherein the m-th round of the candidate recommendation process is as follows: randomly sampling with replacement a total of |P| samples from the unlabeled sample dataset U, where |P| denotes the number of samples in the positive sample dataset P, using the |P| samples to form the negative sample dataset: N^{m}; constructing the training dataset using P and N^{m}:
$${X}_{train}^{m} ,$$
constructing the prediction dataset
$${X}_{test}^{m}$$
using the remaining unsampled samples from U; constructing the vertical federated learning model using Gradient Boosting Decision Tree (GBDT) as the base estimator and training the model on
$${X}_{train}^{m} ;$$
performing prediction on
$${X}_{test}^{m}$$
by inputting it into the trained vertical federated model, and obtaining the prediction score for each sample in
$${X}_{test}^{m} ;$$
the prediction process of the m-th round of the candidate recommendation process for the unlabeled samples specifically comprises the following steps:
S21: using bootstrap sampling to randomly sample with replacement |P| samples from the unlabeled sample dataset U to construct the m-th round negative sample dataset:
$${N}^{m} = \{ ( {xn}_{i}^{m} , {yn}_{i}^{m} ) \} ,$$
where
$${xn}_{i}^{m} = ( {xn}_{i}^{m , B} , {xn}_{i}^{m , C} ) , {xn}_{i}^{m , B} and {xn}_{i}^{m , C}$$
represent the feature vectors of the i-th negative sample in round m from Party B and Party C respectively, and
$${yn}_{i}^{m} ∈ \{ - 1 \}$$
denotes the corresponding label, i=1, 2, . . . , 2|P|; |N^{m}| denotes the number of samples in the m-th round negative sample dataset N^{m}; the positive sample dataset P and the negative sample dataset N^{m} are used to construct the m-th round training set:
$${X}_{train}^{m} = \{ ( {xtr}_{i}^{m} , {ytr}_{i}^{m} ) \} ,$$
where
$$x t {r}_{i}^{m} = ( x t {r}_{i}^{m , B} , xt {r}_{i}^{m , C} ) ; xt {r}_{i}^{m , B} and {xtr}_{i}^{m , C}$$
denote the feature vectors of the i-th sample in the m-th round training set from Party B and Party C respectively, and
$$y t {r}_{i}^{m} ∈ \{ - 1 , 1 \}$$
is its label, i=1, 2, . . . , 2|P|; the remaining unsampled data in the unlabeled sample dataset are used to construct the m-th round prediction set:
$${X}_{test}^{m} = \{ x t {e}_{j}^{m} \} ,$$
where
$$x t {e}_{j}^{m}$$
denotes the j-th sample feature vector in round m, j=1, 2, . . . , |U|−|N^{m}|;
S22: using the GBDT algorithm as the base estimator to construct the vertical federated model; training the model on the training dataset
$${X}_{train}^{m}$$
through an ensemble of T decision trees
$${f}_{t}^{m} ;$$
for each sample
$$x t {r}_{i}^{m} in {X}_{train}^{m} ,$$
predicting the m-th round output denoted as
$${\hat{{y}_{ι}}}^{m} = {\sum }_{t = 1}^{T} {f}_{t}^{m} ( xt {r}_{i}^{m} ) ;$$
where T represents the total number of the decision trees in the m-th round,
$${f}_{t}^{m} ( xt {r}_{i}^{m} )$$
denotes the prediction result of the t-th tree in the m-th round
$$x t {r}_{i}^{m}$$
denotes the feature vector of the i-th sample in the m-th round, i=1, 2, . . . , 2|P|; constructing first-order and second-order gradient histograms based on the gradient values of the loss function between the m-th round prediction output
$${\hat{y}}_{ι}^{m}$$
and the true label
$$y t {r}_{i}^{m} , ;$$
jointly analyzing the gradient histograms of all features from Party B and Party C to determine the global optimal split of the current node so as to construct an optimal decision tree;
S23: using the m-th round, trained GBDT model to perform prediction on the m-th round prediction set
$${X}_{test}^{m}$$
and obtaining the prediction score for each sample
$$x t {e}_{j}^{m}$$
in the prediction set
$${X}_{test}^{m} ;$$
traversing all samples in the unlabeled sample dataset U, identifying the sample xuᵢ in U whose ID is identical to that of
$$x t {e}_{j}^{m} ,$$
and assigning the prediction score of
$$x t {e}_{j}^{m}$$
to xuᵢ as the m-th round prediction score for sample xuᵢ denoted as
$${Oob}_{i}^{m} ,$$
where i=1, . . . , |U| denotes the sample indices in the unlabeled sample dataset U; if a sample xuᵢ in U does not exist in
$${X}_{test}^{m} ,$$
then the corresponding m-th round prediction score
$${Oob}_{i}^{m}$$
for that sample xuᵢ is set to 0.

5. The multi-party semi-supervised learning method for recommending potential users of financial products according to claim 4, wherein, in step S22, a prediction result
$${\hat{y}}_{{ι}_{( 0 )}}^{m}$$
of each sample
$$x t {r}_{i}^{m}$$
in the m-th round is first initialized, where the prediction result
$${\hat{y}}_{{ι}_{( 0 )}}^{m}$$
is a random value, the federated training process of the t-th tree in the m-th round is as follows:
S221: starting from Party B, calculating for each sample
$$x t {r}_{i}^{m , B}$$
the first-order gradient of the loss function in the m-th round:
$${g}_{i}^{m} = {\partial }_{{\hat{y}}_{{ι}_{( t - 1 )}}^{m}} L ( y t {r}_{i}^{m} , {\hat{y}}_{{ι}_{( t - 1 )}}^{m} ) ,$$
and the second-order gradient:
$${h}_{i}^{m} = {\partial }_{{\hat{y}}_{{ι}_{( t - 1 )}}^{m}}^{2} L ( y t {r}_{i}^{m} , {\hat{y}}_{{ι}_{( t - 1 )}}^{m} ) ,$$
where i=1, 2, . . . , 2|P|, represents the prediction result for the sample
$$x t {r}_{i}^{m}$$
aggregated from the previous t−1 trees in the m-th round,
$$y t {r}_{i}^{m}$$
denotes the true label of the i-th sample in the m-th round, and
$$L ( y t {r}_{i}^{m} , {\hat{y}}_{{ι}_{( t - 1 )}}^{m} )$$
is the loss function, performing additive homomorphic encryption on
$${g}_{i}^{m} and {h}_{i}^{m}$$
to obtain
$$\text{?} {g}_{i}^{m} \text{?}$$
$$and$$
$$\text{?} {h}_{i}^{m} \text{?}$$
respectively; Party B sends
$$\text{?} {g}_{i}^{m} \text{?}$$
$$and$$
$$\text{?} {h}_{i}^{m} \text{?}$$
to Party C;
S222: for Party C, constructing the m-th round gradient histogram based on its feature data, and sending the encrypted gradient histogram to Party B;
S223: Party B decrypting the encrypted gradient histogram of the m-th round received from Party C, enumerating each feature gradient histogram to perform optimal solution calculation based on the split gain formula, identifying the global optimal split point, and returning the split information to Party C for interpretation;
S224: Party C determining a feature threshold based on a feature index Kₒₚₜ and a threshold index Vₒₚₜ received from Party B, and partitions the current sample space accordingly; then Party C locally constructing a lookup table recording the feature threshold in the form of [record ID, feature, threshold], and returning the record ID and the left-side partitioned sample space (I_{L}) to Party B;
S225: Party B partitioning the current node based on the received [record ID, I_{L}] and associating the current node with [party, record ID]; Party B synchronizing the node split information with Party C and proceeding to the next node split;
S226: iterating steps S222 to S225 until the training termination condition or the maximum tree depth is reached.

6. The multi-party semi-supervised learning method for recommending potential users of financial products according to claim 5, characterized in that step S222 specifically comprises the following steps:
S2221: for all features of Party C in the current m-th round
$$x t {r}_{i}^{m} ,$$
sorting all the samples based on the feature values of each feature, and then dividing the sorted samples into q buckets, thereby obtaining corresponding feature thresholds:
$${S}_{k , v}^{m} ∈ \{ {S}_{k , 1}^{m} , {S}_{k , 2}^{m} , … , {S}_{k , q}^{m} \}$$
for each category, where k denotes the feature index, and
$${S}_{k , q}^{m}$$
denotes the threshold of the q-th category of the feature index k in the m-th round;
S2222: based on
$$\text{?} {g}_{i}^{m} \text{?}$$
$$and$$
$$\text{?} {h}_{i}^{m} \text{?}$$
of the m-th round received from Party B, Party C performs encrypted gradient aggregation to construct the encrypted gradient histogram of the m-th round as follows:
$${G}_{k , v}^{m} = {\sum }_{i ∈ \{ i \vert {s}_{k , v}^{m} \geq {xtr}_{i , k}^{m} > {s}_{k , v}^{m} \}} \text{?} {g}_{i}^{m} \text{?} ,$$
$${H}_{k , v}^{m} = {\sum }_{i ∈ \{ i \vert {s}_{k v}^{m} \geq {xtr}_{i , k}^{m} > {s}_{k , v - 1}^{m} \}} \text{?} {h}_{i}^{m} \text{?}$$
where i=1, 2, . . . , 2|P|, v=1, 2, . . . , q;
S2223: Party C sends
$${G}_{k , v}^{m}$$
$$and$$
$${H}_{k , v}^{m}$$
of the m-th round to Party B.

7. The multi-party semi-supervised learning method for recommending potential users of financial products according to claim 5, characterized in that step S223 specifically comprises the following steps:
S2231: Party B aggregating the first-order and second-order gradients of all samples in the current node space, performing
$${g}^{m} = {\sum }_{i ∈ I} {g}_{i}^{m} ,$$
$${h}^{m} = {\sum }_{i ∈ I} {h}_{i}^{m} ,$$
where I denotes all samples in the current node;
$${g}_{l}^{m} = {g}_{l}^{m} + D ( {G}_{k , v}^{m} ) ,$$
$${h}_{l}^{m} = {h}_{l}^{m} + D ( {H}_{k , v}^{m} )$$
$${g}_{r}^{m} = {g}^{m} - {g}_{l}^{m} ,$$
$${h}_{r}^{m} = {h}^{m} - {h}_{l}^{m}$$
S2232: Party B decrypting
$${G}_{k , v}^{m}$$
$$and$$
$${H}_{k , v}^{m}$$
of the m-th round received from Party C, obtaining the decrypted values
$$D ( {G}_{k , v}^{m} )$$
$$and$$
$$D ( {H}_{k , v}^{m} )$$
of the m-th round; for each category of every feature from Party C, the following calculations are performed to obtain
$${g}_{l}^{m} ,$$
$${h}_{l}^{m} ,$$
$${g}_{r}^{m}$$
$$and$$
$${h}_{r}^{m} :$$
$${g}_{l}^{m} = {g}_{l}^{m} + D ( {G}_{k , v}^{m} ) ,$$
$${h}_{l}^{m} = {h}_{l}^{m} + D ( {H}_{k , v}^{m} )$$
$${g}_{r}^{m} = {g}^{m} - {g}_{l}^{m} ,$$
$${h}_{r}^{m} = {h}^{m} - {h}_{l}^{m}$$
where I_{L} denotes the sample space of the left child node after the split, I_{R} denotes the sample space of the right child node after the split,
$${g}_{l}^{m} = {\sum }_{i ∈ {I}_{L}} {g}_{i}^{m}$$
denotes the sum of the first-order gradients of all samples in the left child node sample space in the m-th round,
$${h}_{l}^{m} = {\sum }_{i ∈ {I}_{L}} {h}_{i}^{m}$$
denotes the sum of the second-order gradients of all samples in the left child node sample space in the m-th round,
$${g}_{r}^{m} = {\sum }_{i ∈ {I}_{R}} {g}_{i}^{m}$$
denotes the sum of the first-order gradients of all samples in the right child node sample space in the m-th round,
$${h}_{r}^{m} = {\sum }_{i ∈ {I}_{R}} {h}_{i}^{m}$$
denotes the sum of the second-order gradients of all samples in the right child node sample space in the m-th round;
S2233: calculating the optimal split value of the current node in the m-th round
$${ℒ}_{s plit}^{m} :$$
$${ℒ}_{s plit}^{m} = \frac{1}{2} [ \frac{{( {\sum }_{i ∈ {I}_{L}} {g}_{i}^{m} )}^{2}}{{\sum }_{i ∈ {I}_{L}} {h}_{i}^{m} + λ} + \frac{{( {\sum }_{i ∈ {I}_{R}} {g}_{i}^{m} )}^{2}}{{\sum }_{i ∈ {I}_{R}} {h}_{i}^{m} + λ} + \frac{{( {\sum }_{i ∈ I} {g}_{i}^{m} )}^{2}}{{\sum }_{i ∈ I} {h}_{i}^{m} + λ} ] = \frac{1}{2} [ \frac{{g}_{l}^{{m}^{2}}}{{h}_{l}^{m} + λ} + \frac{{g}_{r}^{{m}^{2}}}{{h}_{r}^{m} + λ} + \frac{{g}^{{m}^{2}}}{{h}^{m} + λ} ]$$
where λ is a hyperparameter;
S2234: for all threshold values
$${s}_{k , v}^{m}$$
of each feature of the sample, a corresponding optimal split value
$${ℒ}_{s plit}^{m}$$
is obtained; the maximum
$${ℒ}_{s plit}^{m}$$
among them is selected to determine the corresponding feature threshold as the global optimal split in the m-th round; the global optimal split is represented as [party, feature index (Kₒₚₜ), threshold index (Vₒₚₜ)], and the feature index (Kₒₚₜ) and threshold index (Vₒₚₜ) are returned to Party C.

8. The multi-party semi-supervised learning method for recommending potential users of financial products according to claim 4, characterized in that step S23 specifically comprises the following steps:
S231: Party B querying the record [party, record ID] associated with the current node; based on the record, Party B sending the sample ID to be labeled and the record ID to Party C, and requesting the next tree traversal direction, that is, whether to proceed to the left or the right child node;
S232: upon receiving the to-be-labeled sample ID and record ID, Party C comparing the value of the corresponding feature in the sample to-be-labeled with the threshold recorded in the local lookup table [record ID, feature, threshold], determining the next tree traversal direction, and sending the decision back to Party B;
S233: upon receiving the traversal decision from Party C, Party B proceeding to the corresponding child node;
S234: iterating steps S231 to S233 until a leaf node is reached, and obtaining a classification label and a corresponding weight at that leaf node, thereby determining the m-th round prediction score
$${Oob}_{i}^{m}$$
for the sample xuᵢ in U that corresponds to the sample
$$x t {e}_{j}^{m} :$$
$${Oob}_{i}^{m} = - \frac{{\sum }_{i ∈ I} {g}_{i}^{m}}{{\sum }_{i ∈ I} {h}_{i}^{m} + λ}$$
where I denotes the sample space of the leaf node, and λ is a hyperparameter.

9. The multi-party semi-supervised learning method for recommending potential users of financial products according to claim 4, characterized in that in step S3, the probability of each sample xuᵢ in U being predicted as a positive sample is calculated based on the cumulative sum of its prediction scores over M rounds and the total number of times it appears in the prediction sets of the M rounds; all samples in U are sorted in descending order according to the calculated probability of being a positive sample; based on prior knowledge, the top-ranked samples are selected as reliable positive samples, which are added to the positive sample dataset P and simultaneously removed from U; the step specifically comprises the following substeps:
S31: the probability ρᵢ of each sample xuᵢ in U being predicted as a positive sample is calculated based on the cumulative sum of its prediction scores:
$${\sum }_{m = 1}^{M} {Oob}_{i}^{m}$$
over M rounds and the total number of times it appears in the prediction sets of the M rounds, using the following formula:
$${ρ}_{i} = \frac{{\sum }_{m = 1}^{M} {Oob}_{i}^{m}}{{\sum }_{m = 1}^{M} I ( {xu}_{i} ∈ {X}_{test}^{m} )}$$
where
$$I ( {xu}_{i} ∈ {X}_{test}^{m} )$$
is an indicator function, such that I=1 if the sample xuᵢ in U appears in the prediction set
$${X}_{test}^{m}$$
of the m-th round, and I=0 otherwise;
S32: sorting all samples in U in descending order according to their calculated probabilities ρᵢ, selecting the top θ ranked samples as reliable positive samples, adding them to the positive sample dataset P, and simultaneously removing them from U, where the value of θ is determined based on prior knowledge.
